(19) United States
(12) Patent Application Publication
(10) Pub. No.: US 2011/0205213 A1
(43) Pub. Date: Aug. 25, 2011

(54) LIQUID CRYSTAL DISPLAY DEVICE

(75) Inventor: Hikaru MONDORI, Hachioji-shi (JP)

(73) Assignee: CASIO COMPUTER CO., LTD., Tokyo (JP)

(21) Appl. No.: 13/032,717

(22) Filed: Feb. 23, 2011

(30) Foreign Application Priority Data
Feb. 24, 2010 (JP) 2010-039108

(51) Int. Cl. G09G 5/00; G09G 3/36

(52) U.S. Cl. 345/211; 345/87

(57) ABSTRACT

A liquid crystal display device includes two-column pixel electrodes. The pixel electrodes are arrayed so that a signal line is positioned between the pixel electrodes. The pixel electrodes include a first pixel electrode which is connected to the signal line and a second pixel electrode which is not connected to the signal line. A pixel electrode of a first column of the two columns is set as the first pixel electrode, and a pixel electrode of a second column of the two columns is set as the second pixel electrode in a first row. A pixel electrode of the first column of the two columns is set as the second pixel electrode, and a pixel electrode of the second column of the two columns is set as the first pixel electrode in a second row. At least one of the first and second rows is continuously arranged.

### CROSS-REFERENCE TO RELATED APPLICATIONS

This application is based upon and claims the benefit of priority from prior Japanese Patent Application No. 2010-039108, filed Feb. 24, 2010, the entire contents of which are incorporated herein by reference.

### BACKGROUND OF THE INVENTION

1. Field of the Invention

The invention relates to a liquid crystal display device.

2. Description of the Related Art

A liquid crystal display device has a display panel. The display panel is configured in such a manner that display pixels are two-dimensionally arrayed. Each display pixel is configured in such a manner that a liquid crystal is held between a pixel electrode and a common electrode. The liquid crystal display device applies a voltage to a pixel electrode and a common electrode of a display pixel, and thereby, an applied voltage to a liquid crystal held between these electrodes is controlled to perform display. In liquid crystal, a molecular alignment state changes depending on the magnitude of the applied voltage. Moreover, the liquid crystal display device controls the molecular alignment state, and thereby, controls the quantity of light transmitting through a liquid crystal panel. For example, the magnitude of a voltage (common voltage) applied to a common electrode is set as a constant. Then, a display signal voltage having the magnitude corresponding to image data showing grayscale level information of an image to be displayed is applied to a pixel electrode. In this way, image display at a desired grayscale level is performed.

The characteristics of liquid crystal are degraded if a direct-current voltage is applied for a long time. In order to achieve a liquid crystal with a long lifetime, the polarity of a voltage applied to the liquid crystal is changed using an alternating-current voltage. Specifically, the polarity of a voltage applied to the liquid crystal is changed for every frame displaying an image, which is equivalent to one screen. In order to prevent a flicker from becoming visible due to the polarity inversion of the voltage applied to the liquid crystal, for example, a dot-inversion drive scheme disclosed in Jpn. Pat. Appln. KOKAI Publication No. 2008-292927 was developed. According to this dot-inversion drive scheme, the polarity of a voltage applied to the liquid crystal is spatially changed for each unit of display pixels.

According to the foregoing dot-inversion drive scheme, regarding one signal line, the polarity of the display pixel corresponding to the signal line is inverted for every row. Because of this, there is a need to invert the polarity of a display signal voltage applied to the signal line for one horizontal period. In this case, a polarity inversion frequency becomes relatively high; as a result, this is a factor of causing high power consumption.

### BRIEF SUMMARY OF THE INVENTION

According to a first aspect of the invention, there is provided a liquid crystal display device comprising: a liquid crystal display device comprising: two-column pixel electrodes, the two-column pixel electrodes being arrayed so that a signal line is positioned between the pixel electrodes, and including a first pixel electrode which is connected to the signal line via a thin-film transistor, and a second pixel electrode which is not connected to the signal line, a pixel electrode of a first column of the two columns being set as the first pixel electrode, and a pixel electrode of a second column of the two columns being set as the second pixel electrode, in a predetermined first pixel row, a pixel electrode of the first column of the two columns being set as the second pixel electrode, and a pixel electrode of the second column of the two columns being set as the first pixel electrode, in a second pixel row different from the first pixel row, at least one of the first and second pixel rows being continuously arranged in a predetermined area.

According to a second aspect of the invention, there is provided a liquid crystal display device comprising: first display pixels, which are arrayed as a first pixel column along a first signal line; and second display pixels, which are arrayed as a second pixel column along the first signal line so that the first signal line is positioned between the first pixel column and the second display pixels, one of the first display pixels and one of the second display pixels being arranged adjacent to each other in every pixel row, a predetermined number of continuously arranged pixel rows forming one unit, a display pixel of a mutually different column between neighboring two pixel rows being connected to the first signal line, in the one unit, a select pattern of a display pixel given as a connection target to the first signal line being a select pattern in which the display pixel is mirror-inverted using a direction orthogonal to the first signal line as an axis between two units neighboring along the first signal line.

According to a third aspect of the invention, there is provided a liquid crystal display device comprising: a first signal line, which is arranged in a predetermined direction; a second signal line, which is arranged in parallel with the first signal line and adjacent to the second signal line; and display pixels arrayed in one column along the first and second signal line between the first and second signal lines, the display pixels being configured so that a predetermined number of continuously arrayed display pixels form one unit, a display pixel being connected to any one of the first and second signal lines so that a signal line connected with a display pixel is mutually different between two display pixels neighboring in the column direction, in the unit, a select pattern of a signal line given as a connection target to a display pixel is mutually inverted between neighboring two units.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing the appearance of a mobile phone given as an example of an electronic apparatus including a liquid crystal display device according to an embodiment of the invention;

FIG. 2 is a block diagram showing the configuration of the liquid crystal display device according to an embodiment of the invention;

FIG. 3 is a block diagram showing the configuration of a signal driver;

FIG. 4A is a view to explain a polarity inversion of a display signal voltage in an odd frame when a method of driving a liquid crystal display device according to an embodiment of the invention is applied;

FIG. 4B is a view to explain a polarity inversion of a display signal voltage in an even frame when a method of driving a liquid crystal display device according to an embodiment of the invention is applied;

FIG. 5A is a timing chart showing the polarity of a display signal voltage applied to a signal line S (3) in an odd frame;

FIG. 5B is a timing chart showing the polarity of a display signal voltage applied to a signal line S (3) in an even frame;

FIG. 6A is a view showing the pixel configuration of a modification example in which the pixel configuration shown in FIG. 2 is shifted down by one row, and to explain a polarity inversion of a display signal voltage in an odd frame;

FIG. 6B is a view showing the pixel configuration of a modification example in which the pixel configuration shown in FIG. 2 is shifted down by one row, and to explain a polarity inversion of a display signal voltage in an even frame;

FIG. 7 is a timing chart showing the polarity of a display signal voltage applied to a signal line S (3) in the modification example shown in FIGS. 6A and 6B;

FIG. 8A is a block diagram showing the pixel configuration of a modification example in which three display pixels are included in one unit, and to explain a polarity inversion of a display signal voltage in an odd frame;

FIG. 8B is a block diagram showing the pixel configuration of a modification example in which three display pixels are included in one unit, and to explain a polarity inversion of a display signal voltage in an even frame;

FIG. 9 is a timing chart showing the polarity of a display signal voltage applied to a signal line S (3) in the modification example shown in FIGS. 8A and 8B;

FIG. 10A is a block diagram showing the pixel configuration of a modification example in which four display pixels are included in one unit, and to explain a polarity inversion of a display signal voltage in an odd frame;

FIG. 10B is a block diagram showing the pixel configuration of a modification example in which four display pixels are included in one unit, and to explain a polarity inversion of a display signal voltage in an even frame; and

FIG. 11 is a timing chart showing the polarity of a display signal voltage applied to a signal line S (3) in the modification example shown in FIGS. 10A and 10B.

### DETAILED DESCRIPTION OF THE INVENTION

Various embodiments of the invention will be hereinafter described with reference to the accompanying drawings.

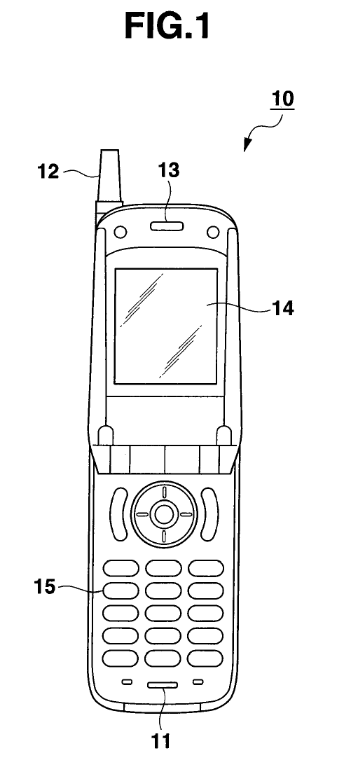

FIG. 1 is a view showing the appearance of a mobile phone given as an example of an electronic apparatus including a liquid crystal display device according to an embodiment of the invention. A mobile phone 10 shown in FIG. 1 includes a microphone 11, an antenna 12, a speaker 13, a liquid crystal display device 14 and an operating unit 15.

The microphone 11 electrically converts a voice input by the user of the mobile phone 10. The antenna 12 is used for performing communication of the mobile phone with a base station (not shown). The speaker 13 converts a voice signal received by the antenna 12 from another mobile phone by way of a base station, and then, outputs the converted voice. The liquid crystal display device 14 displays various images. The operating unit is used for operating the mobile phone 10 by the user of the mobile phone 10.

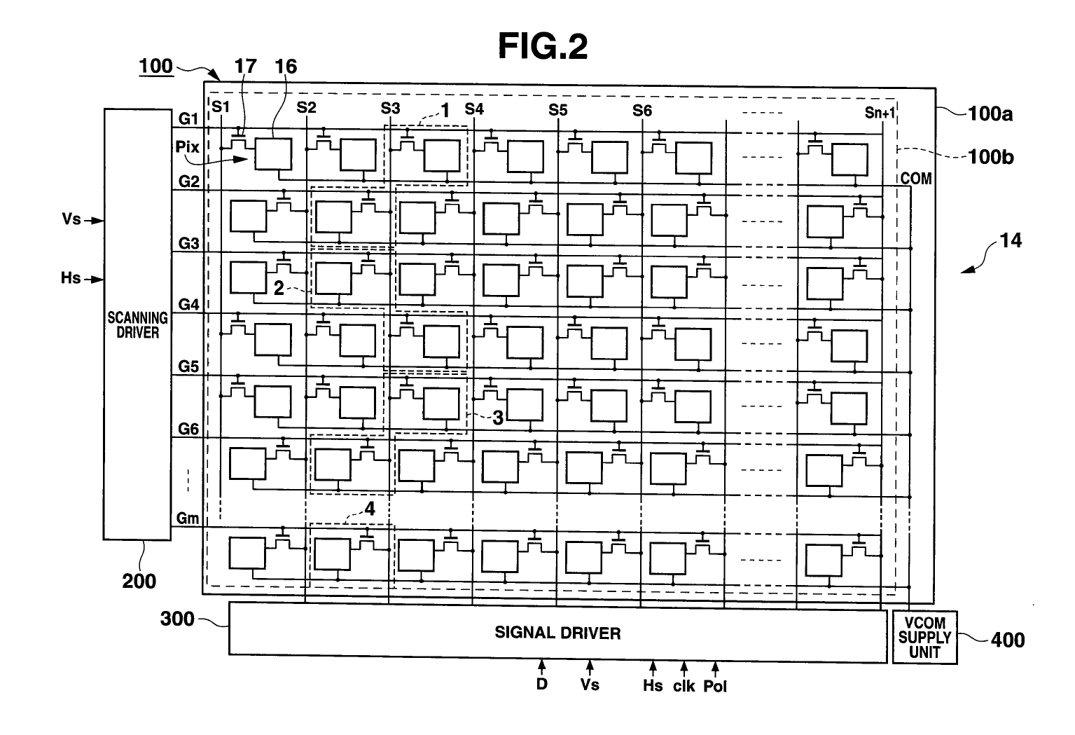

FIG. 2 is a block diagram showing the configuration of a liquid crystal display device 14 according to an embodiment of the invention. As shown in FIG. 2, the liquid crystal display device 14 includes a display panel 100, a scanning driver 200, a signal driver 300 and a VCOM supply unit 400.

The display panel 100 displays an image based on image data supplied from the outside of the liquid crystal display device 14 on a display area. The display panel 100 is configured in such a manner that liquid crystal is interposed between first and second substrates 100a and 100b. The liquid crystal display device 14 is incorporated from an opening portion formed in a housing body of the mobile phone 10 to the housing body thereof so that the display area of the display panel 100 is exposed. Moreover, of the foregoing first and second substrates 100a and 100b, the second substrate 100b is arranged as a substrate of the side that is exposed from the housing body of the mobile phone 10.

The display area of the display panel 100 is provided with display pixels Pix, which are arrayed in m rows×n columns. Specifically, the first substrate 100a of the display panel 100 is provided with a plurality of scanning lines G (i) (i=1, 2, . . . m) and a plurality of signal lines S (j) (j=1, 2, . . . , n, n+1) (increased by one compared with the number of columns of the display pixels Pix). In this case, these scanning lines G and signal lines S are arranged so that they cross each other. The position corresponding to the intersection of the scanning line G (i) and the signal line S (j) is provided with a pixel electrode 16. The pixel electrode 16 forms a display pixel Pix together with a common electrode of the second substrate 100b. The pixel electrode 16 is formed of a transparent conductive film such as ITO (indium tin oxide), for example. Further, the pixel electrode 16 is connected to the scanning line G (i) and the signal line S (j) by way of a thin-film transistor (TFT) 17 functioning as a switching element. The TFT 17 includes a gate electrode connected to a scanning line, a source electrode and a drain electrode. One of the source electrode and the drain electrode is connected to a signal line, and the other thereof is connected to a pixel electrode. The total number of the pixel electrodes 16 is (m×n), and also, the total number of TFTs is (m×n).

The second substrate 100b of the display panel 100 is arranged to oppose the first substrate 100a. The second substrate 100b is formed with a common electrode COM.

Moreover, the second substrate 100b is bonded to the first substrate 100a by means of a frame-like sealing material. Liquid crystal is encapsulated in an area surrounded by a frame formed by the sealing material.

In the display panel 100, one display pixel Pix is formed by means of a pixel electrode 16 and TFT 17, which are formed on the first substrate 100a, liquid crystal held between the first and second substrates 100a and 100b, and the common electrode COM formed on the second substrate 100b. The display pixel Pix is two-dimensionally arrayed because the foregoing pixel electrode 16 and TFT 17 are arrayed as shown in FIG. 2. In the following description, the direction along the scanning line is defined as the row direction of the display panel 100. Moreover, the direction along the signal line is defined as the column direction of the display panel 100. In addition, display pixels Pix arrayed on the uppermost row in the display panel 100 are defined as a first row display pixel. Moreover, display pixels Pix arrayed on the leftmost column in the display panel 100 are defined as a first column display pixel.

According to this embodiment, a predetermined display pixel Pix of two column display pixels arrayed via a j-th column signal line S (j) (i.e., (j−1)-th column display pixels Pix and j-th column display pixels Pix) is connected to a signal line S (j). The display pixel Pix connected to a signal line S (j) is only one of two display pixels Pix neighboring in the row direction. Moreover, there is a select pattern of display pixels Pix given as a connection target. Namely, k continuous rows of pixels represent a predetermined select pattern unit.

In other words, a predetermined pixel electrode 16 of two column pixel electrodes arrayed via a j-th column signal line S (j) (i.e., (j−1)-th column pixel electrodes 16 and j-th column pixel electrodes 16) is connected to a signal line S (j) via the corresponding TFT 17. The pixel electrode 16 connected to a signal line S (j) via the TFT 17 is only one of two pixel electrodes 16 neighboring in the row direction. Moreover, there is a select pattern of pixel electrodes 16 given as a connection target. Namely, k continuous rows of pixel electrodes represent a predetermined select pattern unit.

In the unit, display pixels Pix arrayed on mutually different sides via a signal line S (j) are alternately connected to the signal line S (j) for every row. Namely, the display pixels Pix connected to the signal line S (j) are positioned on the mutually different sides with respect to the signal line S (j) between neighboring two rows.

Moreover, a select pattern of display pixels given as a connection target to a signal line S (j) is different between two units neighboring along the column direction. The relationship between a signal line S (j) and a display pixel is a select pattern, which is mirror-inverted using the direction along a signal line S (j) as the axis. Therefore, the lowermost row display pixel in a unit and the uppermost row display pixel in the next unit neighboring in the column direction with respect to the foregoing unit are the same column display pixels.

For example, a broken line frame of FIG. 2 shows display pixels Pix, which belong to each unit connected to a signal line S (3). In this case, one unit is formed by means of two display pixels Pix. Hereinafter, numbers 1, 2, 3 . . . are successively given from the upper side unit of the display panel 100.

For example, if attention is given to a signal line S (3), in a first unit comprising first and second row display pixels Pix, a third column display pixel Pix is connected as a first row display pixel and a second column display pixel Pix is connected as a second row display pixel. In a second unit comprising third and fourth row display pixels Pix, a second column display pixel Pix is connected as a third row display pixel and a third column display pixel Pix is connected as a fourth row display pixel. In a third unit comprising fifth and sixth row display pixels Pix, the same select pattern of display pixels as the first unit is hereinafter repeated. In an odd unit, display pixels Pix are connected from the upper side row toward the lower side row in the order of third and second columns. In an even unit, display pixels Pix are connected from the upper side row toward the lower side row in the order of second and third columns.

If the display pixel Pix is generally expressed using a signal line (j), in an odd unit, display pixels Pix are connected to a signal line S (j) from the upper row toward the lower row in the order of j-th column and (j−1)-th column. In an even unit, display pixels Pix are connected to a signal line S (j) from the upper row toward the lower row in the order of (j−1)-th column and j-th column. According to a select pattern of display pixels, in an odd unit, display pixels Pix may be connected to a signal line S (j) from the upper row toward the lower row in the order of (j−1)-th column and j-th column. In an even unit, display pixels Pix may be connected to a signal line S (j) from the upper row toward the lower row in the order of j-th column and (j−1)-th column. In the signal line S (1) and the signal line S (n+1) corresponding to the edge column of the display panel 100, display pixels Pix are not arranged to hold each signal line between display pixels. For this reason, the number of display pixels Pix forming each unit is one.

As described above, the display panel 100 includes display pixels arrayed as a first pixel column along a first signal line (e.g., S (3)), and display pixels arrayed as a second pixel column along the first signal line. The first signal line is positioned between the first pixel column and the second pixel column. Moreover, any one of display pixels Pix arrayed as the first pixel column and any one of display pixels Pix arrayed as the second pixel column are arranged adjacent to each other. Continuously arrayed pixel rows of a predetermined number are defined as one unit. In one unit, display pixels of mutually different columns are connected to the first signal line between neighboring two pixel rows. In two units neighboring along the first signal line, there is a display pixel select pattern given as a connection target to the first signal line. Namely, these display pixels are mirror-inverted using the direction orthogonal to the first signal line as the axis.

Further, the display panel 100 includes a second signal line (e.g., S (2)) arranged so that the first pixel column is positioned between the first signal line and the second signal line. Of display pixels arrayed as the first pixel column, display pixels which are not connected to the first signal line are connected to the second signal line.

Further, the display panel 100 includes a third signal line (e.g., S (4)) arranged so that the second pixel column is positioned between the first signal line and the third signal line. Of display pixels arrayed as the second pixel column, display pixels which are not connected to the first signal line are connected to the third signal line.

The scanning driver 200 is configured including a shift register. The scanning driver 200 successively applies a scanning signal to scanning lines G (i) of the display panel 100. The scanning driver 200 starts to apply a scanning signal to m scanning lines every time a vertical synchronizing signal Vs is input from a controller (not shown). In this case, the scanning driver 200 changes a scanning signal for turning on TFTs for one row from a gate off level to a gate on level every time a horizontal control signal Hs is received from a controller (not shown). In this way, display pixels Pix connected to TFTs for one row are in a state of being selected. The foregoing vertical synchronizing signal Vs is applied for every frame. One frame is a period for displaying one screen of the display panel 100. Moreover, the horizontal control signal Hs is applied every one horizontal period. One horizontal period is a period for writing a display signal voltage (grayscale signal) for one row (i.e., one scanning line) of the display panel 100.

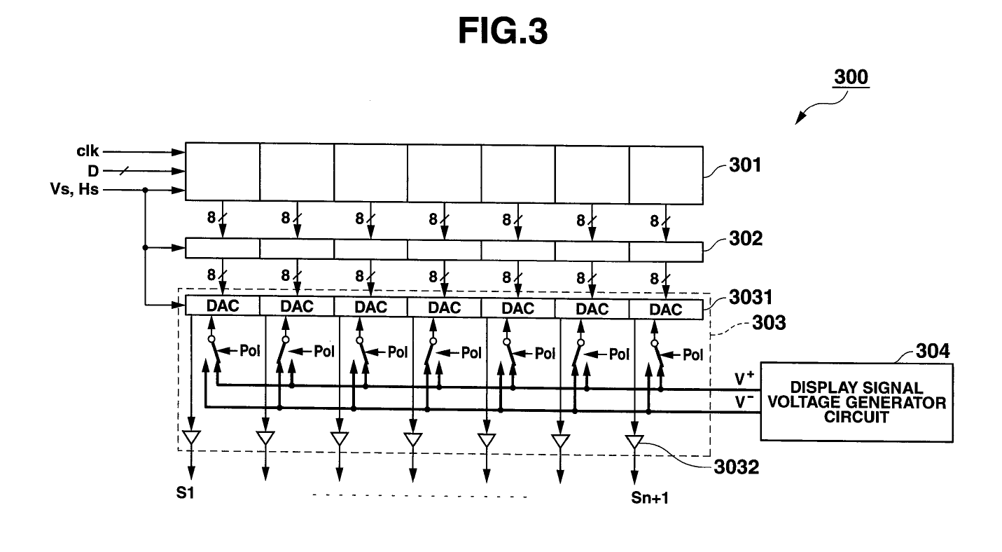

The signal driver 300 having a function as a display signal voltage applying unit applies a display signal voltage to a signal line S (j) of the display panel 100. As shown in FIG. 3, the signal driver 300 includes a sampling memory 301, a data latch 302, a digital-to-analog (D/A) converter circuit (DAC) 303 and a display signal voltage generator circuit 304.

The sampling memory 301 receives a horizontal synchronizing signal Hs from a controller (not shown). Then, the sampling memory 301 successively stores image data D corresponding to n display pixels Pix equivalent to one horizontal period by one display pixel in synchrony with a reference clock signal clk.

Therefore, the sampling memory 301 includes the same number (n+1) of data storage areas as signal lines S (j). In this case, the foregoing image data D is grayscale level information to be displayed by each display pixel, for example, expressed as 8-bit digital data.

The data latch 302 receives a horizontal synchronizing signal Hs from a controller (not shown), and then, collectively captures image data D for one horizontal period stored in each storage area of the sampling memory 301. Thereafter, the data latch 302 outputs the captured image data D to the D/A converter circuit 303.

The D/A converter circuit 303 decodes the image data D output from the data latch 302. Then, the D/A converter circuit 303 selects a display signal voltage corresponding to grayscale level information given as the decoded result from the display signal voltage supplied from the display signal voltage generator circuit 304. Thereafter, the circuit 303 outputs the selected display signal voltage to the corresponding signal line S (j). The D/A converter circuit 303 includes a plurality of analog-to-digital converters (DACs) 3031 and output amplifiers 3032. The DAC 3031 selects a display signal voltage supplied from the display signal voltage generator circuit 304 in accordance with the decoded result of the image data D. The output amplifier 3032 amplifies the display signal voltage selected by the corresponding DAC 3031, and thereafter, outputs the amplified voltage to the corresponding signal line S (j). The display signal voltage output to the signal line S (j) is applied to a pixel electrode by way of a TFT, which is turned on by the scanning driver 200. In this way, a voltage of the difference between a pixel electrode voltage generated in a pixel electrode by the foregoing application of display signal voltage and a common voltage is applied to the liquid crystal held between the foregoing electrodes. Thereby, image display at the corresponding display pixel is performed.

The display signal voltage generator circuit 304 generates a display signal voltage corresponding to grayscale levels (e.g., 256 grayscales if D is expressed as 8-bit digital data) capturable by image data D according to a resistance division method, for example. According to the resistance division method, a predetermined power source voltage is divided by a plurality of resistances corresponding to grayscale levels to generate a display signal voltage.

The characteristics of liquid crystal are degraded if a direct-current voltage is applied for a long time. Therefore, in order for a liquid crystal to have a long lifetime, preferably, the polarity (i.e., relationship of magnitude between a pixel electrode voltage and a common voltage) of a voltage applied to the liquid crystal is inverted using an alternating-current voltage. Further, in order to prevent a flicker from becoming visible due to the polarity inversion of the voltage applied to the liquid crystal, a dot-inversion drive scheme is carried out. According to this dot-inversion drive scheme, the polarity of a voltage applied to the liquid crystal is spatially changed for each unit of display pixels.

In order to perform the foregoing dot-inversion drive scheme, the display signal voltage generator circuit 304 is configured to generate the following display signal voltages. One is a display signal voltage V⁺ in which a voltage level becomes a positive pole with respect to a common voltage. The other is a display signal voltage V⁻ in which a voltage level becomes a negative pole with respect to a common voltage. The foregoing display signal voltages V⁺ and V⁻ each have a voltage level corresponding to grayscale levels (e.g., 256 grayscales if D is expressed as 8-bit digital data) capturable by image data D. According to the foregoing configuration, the display signal voltage generator circuit 304 selects any of a positive-pole display signal voltage V⁺ and a negative-pole display signal voltage V⁻ in accordance with a polarity inversion control signal Pol from a controller (not shown). Then, the circuit 304 supplies the selected voltage to the D/A converter circuit 303. For example, if the polarity inversion control signal Pol is a high level, the display signal voltage generator circuit 304 selects a display signal voltage V⁺. Conversely, if the polarity inversion control signal Pol is a low level, the display signal voltage generator circuit 304 selects a display signal voltage V⁻.

The VCOM supply unit 400 generates a common voltage from a predetermined power source, and then, applies the generated common voltage to a common electrode formed on the second substrate 100b. According to this embodiment, the foregoing common voltage is a direct-current voltage having a fixed potential level.

A method of driving a liquid crystal display device according to this embodiment will be described below. According to this embodiment, a display signal voltage is applied to a pixel electrode so that the polarity of the display signal voltage is different between two display pixels neighboring in the column direction and between two display pixels neighboring in the row direction. The following is an explanation of the case of driving each display pixel so that the polarity of a voltage applied to liquid crystal is different between two display pixels neighboring in the column direction and between two display pixels neighboring in the row direction.

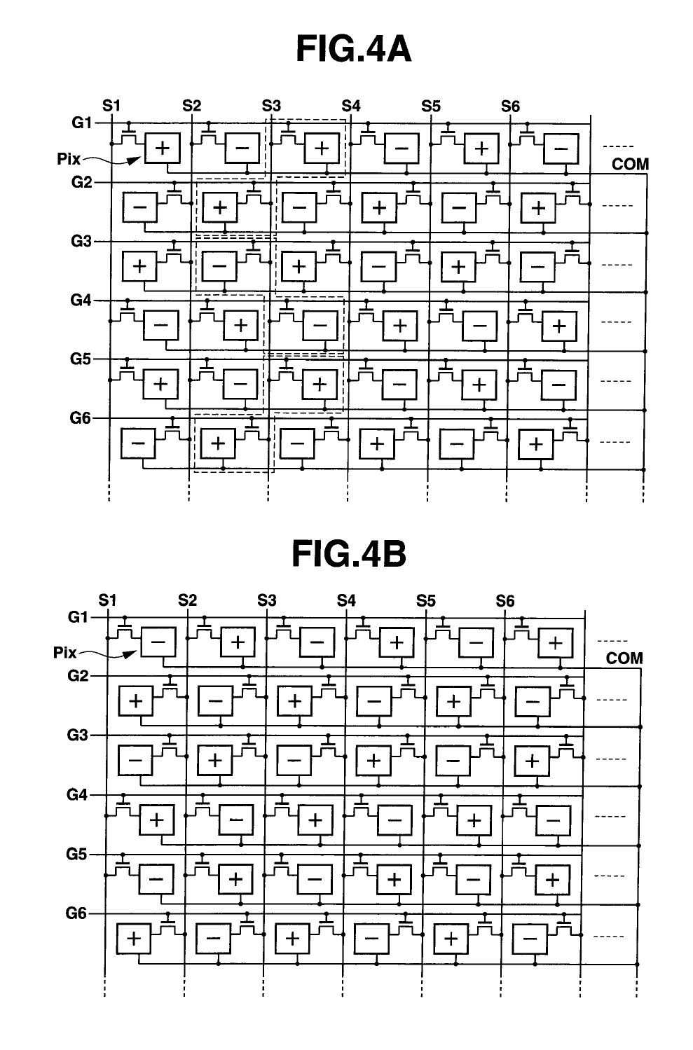

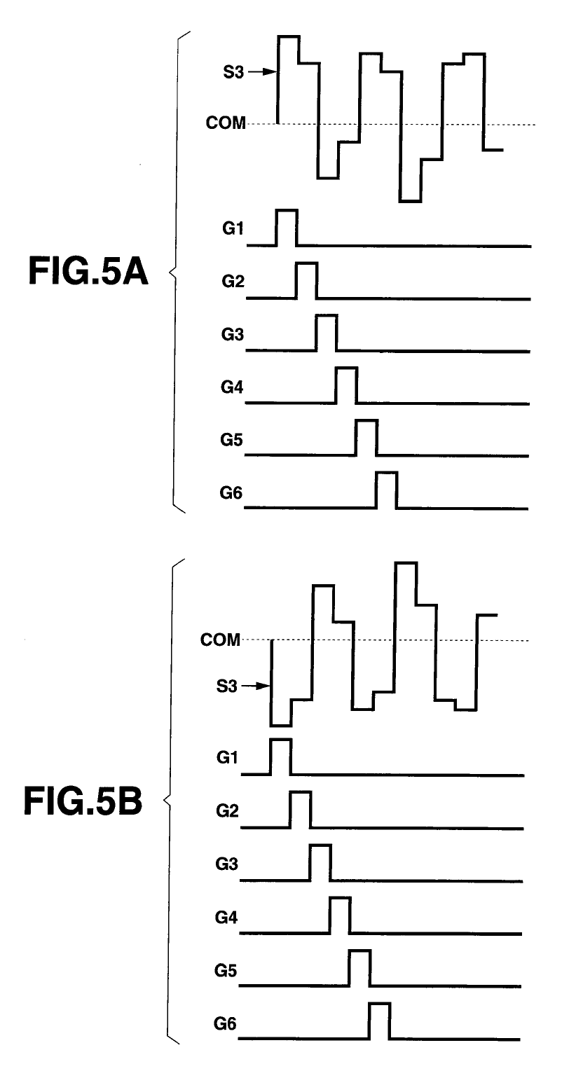

FIGS. 4A and 4B are views to explain a polarity inversion of a display signal voltage when a method of driving a liquid crystal display device according to this embodiment is applied. FIGS. 4A and 5A show the polarity of a voltage applied to liquid crystal or display signal voltage in an odd frame. FIGS. 4B and 5B show the polarity of a voltage applied to liquid crystal or display signal voltage in an even frame.

According to this embodiment, the polarity of a display signal voltage applied to each signal line is inverted for each number of display pixels Pix forming the foregoing unit. Further, the polarity of a display signal voltage is inverted between neighboring signal lines and between odd and even frames.

For example, in FIG. 2, one unit is configured using two display pixels Pix. In this case, the polarity of a display signal voltage is inverted every two horizontal periods (i.e., period in which two display pixels forming one unit are in a selectable state). For example, regarding signal line S (3), as can be seen from FIG. 5A, the polarity of a display signal voltage applied to the signal line S (3) in an odd frame is as follows. Namely, the polarity becomes positive for a period in which a first row scanning line G1 is selected as a scanning line corresponding to a first row display pixel and a period in which a second row scanning line G2 is selected as a scanning line corresponding to a second row display pixel. Conversely, the polarity becomes negative for a period in which a third row scanning line G3 is selected as a scanning line corresponding to a third row display pixel and a period in which a fourth row scanning line G4 is selected as a scanning line corresponding to a fourth row display pixel. Likewise, the positive and negative poles are inverted every two horizontal periods. Moreover, as can be seen from FIG. 5B, the polarity of a display signal voltage applied to the signal line S (3) in an even frame is as follows. Namely, the polarity becomes negative for a period in which first and second row scanning lines G1 and G2 are selected. Conversely, the polarity becomes positive for periods in which third and fourth row scanning lines G3 and G4 are selected. Likewise, the positive and negative poles are inverted every two horizontal periods.

If attention is given to a signal line S (4) neighboring the signal line S (3), the polarity of a display signal voltage applied to the signal line S (4) in an odd frame is as follows. Namely, the polarity becomes negative for periods in which first and second row scanning lines G1 and G2 are selected. Conversely, the polarity becomes positive for periods in which third and fourth row scanning lines G3 and G4 are selected. Likewise, the positive and negative poles are inverted every two horizontal periods. Moreover, the polarity of a display signal voltage applied to the signal line S (4) in an even frame is as follows. Namely, the polarity becomes positive for periods in which first and second row scanning lines G1 and G2 are selected. Conversely, the polarity becomes negative for periods in which third and fourth row scanning lines G3 and G4 are selected. Likewise, the positive and negative poles are inverted every two horizontal periods.

In the manner described above, the polarity of a display signal voltage applied to each signal line is inverted. Therefore, as shown in FIGS. 4A and 4B, the polarity of a voltage applied to liquid crystal is controlled to be different between two display pixels neighboring in the column direction and between two display pixels neighboring in the row direction. In other words, the polarity of a display signal voltage is inverted every two horizontal periods, and simultaneously, it is possible to perform a dot-inversion drive scheme in which the polarity of a voltage applied to liquid crystal is inverted for every display pixel.

As described above, according to this embodiment, display pixels Pix arrayed by one column via a j column signal line S (j) (i.e., (j−1)-th column display pixel Pix and j-th column display pixel Pix) are connected to a signal line S (j) for every unit of k display pixels Pix. In each unit, display pixels arrayed by one column via a signal line S (j) are alternately connected to the signal line S (j) every row, that is, i-th row scanning line G (i). The lowermost display pixel in each unit and the uppermost display pixel in the next unit neighboring in the column direction with respect to the unit are connected in the following manner. Namely, these display pixels are connected to become the same-column display pixels Pix of display pixels Pix arrayed in one column via a signal line S (j).

In the manner described above, the display pixel Pix is connected to a signal line, and thereby, the following connection is made when viewing the display pixel Pix held between neighboring two signal lines of the display panel 100. Specifically, the first row display pixel Pix and the second row display pixel Pix are connected to a mutually different signal line. Likewise, the second and third row display pixels Pix, the third and fourth row display pixels Pix . . . (k−1)-th and k-th row display pixels Pix are connected to a mutually different signal line. However, the k-th row display pixel Pix and (k+1)-th row display pixel Pix are connected to the same signal line. Moreover, (k+1)-th row display pixel Pix and (k+2)-th row display pixel Pix are connected to a mutually different signal line. Likewise, (k+2)-th row display pixel Pix and (k+3)-th row display pixel Pix, (k+3)-th row display pixel Pix and (k+4)-th row display pixel Pix . . . (2k−1)-th row display pixel Pix and 2k-th row display pixel Pix are connected to a mutually different signal line. Each of k display pixels is called a group.

In the foregoing state in which display pixels Pix are connected, the polarity of a display signal voltage applied to a signal line is inverted every two horizontal periods as shown in FIGS. 5A and 5B. In this way, a dot-inversion drive scheme shown in FIGS. 4A and 4B is realized. Namely, a polarity inversion timing of a display signal voltage applied to one signal line is settable to one time every two horizontal periods to perform a dot-inversion drive scheme. Therefore, this serves to reduce a polarity inversion frequency, and thus, to achieve a reduction in power consumption.

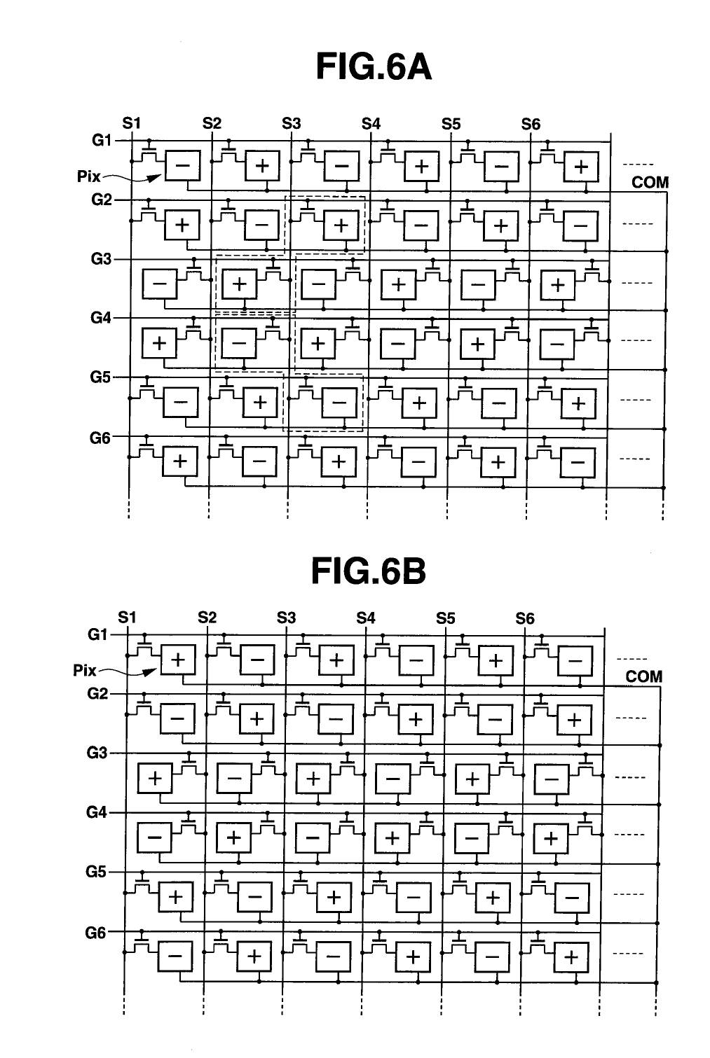

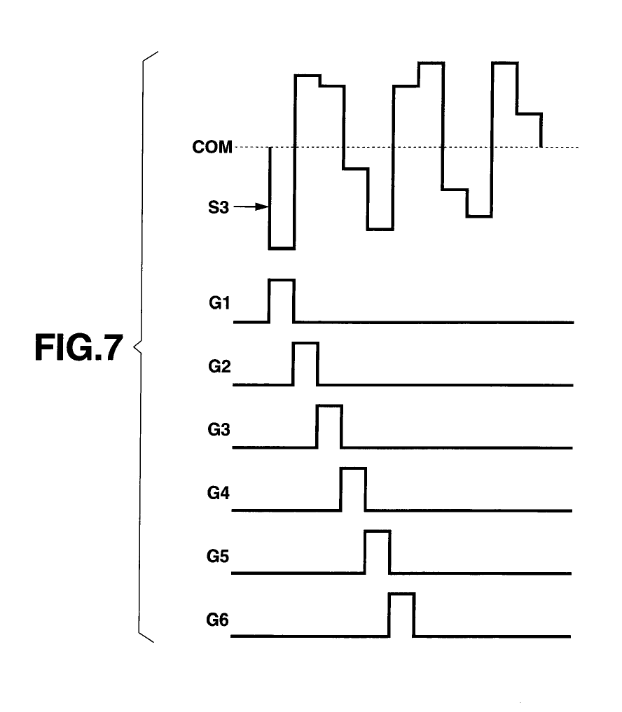

In this case, according to the pixel configuration shown in FIG. 2, power consumption can be reduced even if some pixels are shifted in up and down and right and left directions. For example, FIGS. 6A and 6B show a state in which the pixel configuration shown in FIG. 2 is shifted down by one pixel (one row). In this case, as can be seen from FIGS. 6A and 6B, the polarity of a display signal voltage applied to each signal line is inverted for one horizontal period in only periods corresponding to first and second row display pixels Pix. Thereafter, the polarity of a display signal voltage is inverted every two horizontal periods. FIG. 7 is a timing chart when the foregoing dot-inversion drive scheme is carried out. When the dot-inversion drive scheme shown in FIGS. 6A and 6B is carried out, after at least the second row, a polarity inversion timing of a display signal voltage is set to one time every two horizontal periods.

According to the configuration example of FIG. 2, the number of display pixels Pix forming one unit is set to two. Namely, a select pattern of connected display pixels Pix is a repeating pattern in units of two rows. In this case, the number of display pixels Pix forming one unit may be set to two or more.

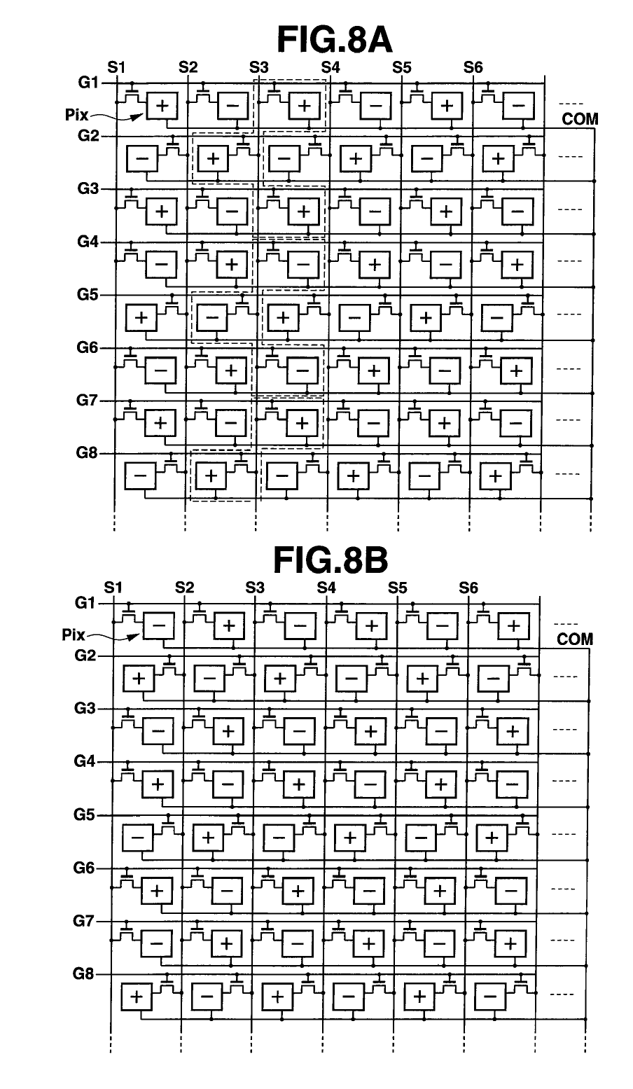

For example, FIGS. 8A and 8B show the case where the number of display pixels Pix forming one unit is set to three. In this case, as shown in FIGS. 8A and 8B, in an odd unit, display pixels Pix are connected to a signal line S (j) in the order of j-th column, (j−1)-th column and j-th column. In an even unit, display pixels Pix are connected to a signal line S (j) in the order of (j−1)-th column, j-th) column and (j−1)-th column. Moreover, in an odd unit, display pixels Pix may be connected to a signal line S (j) in the order of (j−1)-th column, j-th column, and (j−1)-th column. In an even unit, display pixels Pix may be connected to a signal line S (j) in the order of j-th column, (j−1)-th column and j-th column.

The number of display pixels Pix forming one unit is set to three; therefore, the polarity of a display signal voltage is inverted every three horizontal periods. For example, regarding a signal S (3), the polarity of a display signal voltage applied to the signal line S (3) in an odd frame is as follows. Specifically, as can be seen from FIG. 8A, the polarity of the first to third rows is set to positive, the polarity of the fourth to sixth rows is set to negative, the polarity of the seventh to ninth rows is set to positive, . . . . Moreover, the polarity of a display signal voltage applied to the signal line S (3) in an even frame is as follows. Specifically, as can be seen from FIG. 8B, the polarity of the first to third rows is set to negative, the polarity of the fourth to the sixth rows is set to positive, the polarity of the seventh to ninth rows is set to negative, . . . .

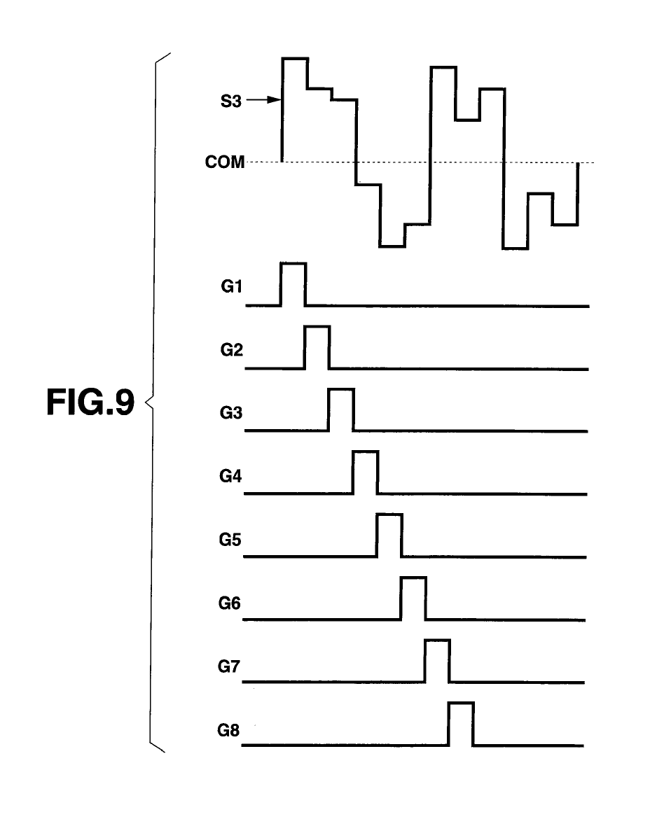

According to the pixel configuration shown in FIGS. 8A and 8B, a polarity inversion of a display signal voltage is carried out as shown in FIGS. 8A and 8B, and thereby, a dot-inversion drive scheme is realized. FIG. 9 is a timing chart when a dot-inversion drive scheme shown in FIGS. 8A and 8B is carried out. When the foregoing dot-inversion drive scheme shown in FIGS. 8A and 8B is carried out, a polarity inversion frequency of a display signal voltage is set to one time every three horizontal periods, as shown in FIG. 9. Therefore, this serves to further reduce power consumption.

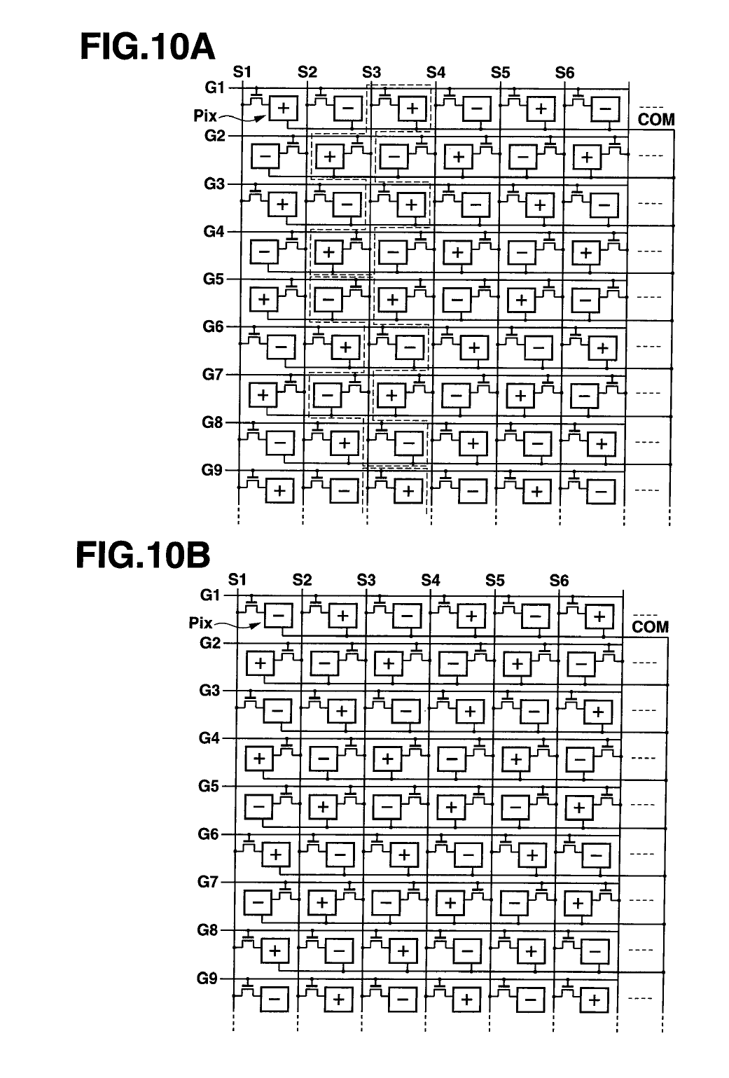

FIGS. 10A and 10B show the case where the number of display pixels Pix forming one unit is set to four. In this case, as shown in FIGS. 10A and 10B, in an odd unit, display pixels Pix are connected to a signal line S (j) in the order of j-th column, (j−1)-th column, j-th column and (j−1)-th column. In an even unit, display pixels Pix are connected to a signal line S (j) in the order of (j−1)-th column, j-th column, (j−1)-th column and j-th column. Moreover, in an odd unit, display pixels Pix may be connected to a signal line S (j) in the order of (j−1)-th column, j-th column, (j−1)-th column and j-th column. In an even unit, display pixels Pix may be connected to a signal line S (j) in the order of j-th column, (j−1)-th column, j-th column and (j−1)-th column.

The number of display pixels Pix forming one unit is set to four; therefore, the polarity of a display signal voltage is inverted every four horizontal periods. For example, regarding a signal S (3), the polarity of a display signal voltage applied to the signal line S (3) in an odd frame is as follows. Specifically, as can be seen from FIG. 10A, the polarity of the first to fourth rows is set to positive, the polarity of the fifth to eighth rows is set to negative, the polarity of the ninth to 12-th rows is set to positive, . . . . Moreover, the polarity of a display signal voltage applied to the signal line S (3) in an even frame is as follows. Specifically, as can be seen from FIG. 10B, the polarity of the first to fourth rows is set to negative, the polarity of the fifth to eighth rows is set to positive, the polarity of the ninth to 12-th rows is set to negative, . . . .

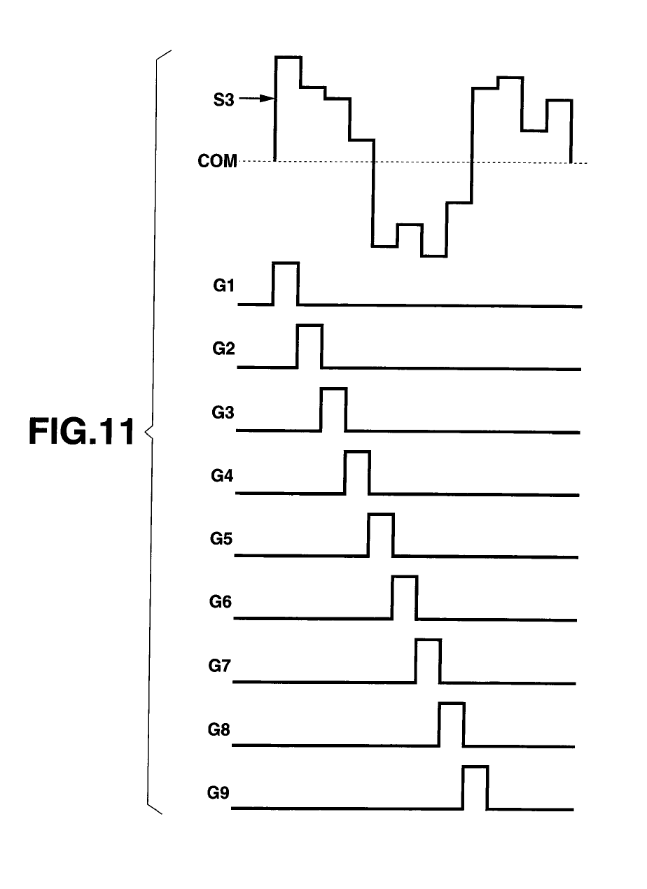

According to the pixel configuration shown in FIGS. 10A and 10B, a polarity inversion of a display signal voltage is carried out as shown in FIGS. 10A and 10B, and thereby, a dot-inversion drive scheme is realized. FIG. 11 is a timing chart when a dot-inversion drive scheme shown in FIGS. 10A and 10B is carried out. When the foregoing dot-inversion drive scheme shown in FIGS. 10A and 10B is carried out, a polarity inversion frequency of a display signal voltage is set to one time every four horizontal periods as shown in FIG. 11. Therefore, this serves to further reduce power consumption.

As described above, the number of display pixels forming one unit is increased, and thereby, a polarity inversion frequency of a display signal voltage is reduced. In this way, a dot-inversion drive scheme can be performed. For example, if the number k of display pixels forming one unit is set to (n/2), drive changes in the vicinity of the center of the display panel 100. This is a factor affecting visibility. Therefore, it is preferable to determine the foregoing number k of display pixels forming one unit taking both of a polarity inversion frequency of a display signal voltage and visibility into consideration.

If the number k of display pixels forming one unit exceeds (n/2), a second unit is short of the number of rows. In this case, the polarity inversion is stopped at the last m row.

The foregoing configuration is provided, and thereby, when viewing display pixels Pix held between two signal lines neighboring in the display panel 100 along the column direction, the number of display pixels forming one group is set to k. In this way, the polarity is inverted for every dot in the column direction in all cases, that is, FIGS. 4A and 4B and FIGS. 6A and 6B (case of K=2), FIGS. 8A and 8B (case of K=3), and FIGS. 4A and 4B (case of K=4). Namely, a dot-inversion drive scheme is performed.

The invention has been described based on the embodiment; however, the invention is not limited to the foregoing embodiment. Of course, various modifications and applications are possible within the scope of the subject matter of the invention. For example, the foregoing embodiment shows an example of the application to a dot-inversion drive scheme; in this case, this embodiment is applicable to a two-dot-inversion drive scheme, and other-dot-inversion drive scheme.

Moreover, the foregoing embodiment includes various steps of inventions and appropriate combinations of disclosed constituent components, and thereby, various inventions can be extracted. For example, even if some constituent components are deleted from all constituent components disclosed in this embodiment, it is possible to solve the foregoing problem. As long as the foregoing effect is obtained, a configuration omitting some of the constituent components may be extracted as the invention.

What is claimed is:

1. A liquid crystal display device comprising:
two-column pixel electrodes, the two-column pixel electrodes being arrayed so that a signal line is positioned between the pixel electrodes, and including a first pixel electrode which is connected to the signal line via a thin-film transistor, and a second pixel electrode which is not connected to the signal line,
a pixel electrode of a first column of the two columns being set as the first pixel electrode, and a pixel electrode of a second column of the two columns being set as the second pixel electrode, in a predetermined first pixel row,
a pixel electrode of the first column of the two columns being set as the second pixel electrode, and a pixel electrode of the second column of the two columns being set as the first pixel electrode, in a second pixel row different from the first pixel row,
at least one of the first and second pixel rows being continuously arranged in a predetermined area.

2. The device according to claim 1, wherein the first and second pixel rows are alternately arranged in an area different from the predetermined area.

3. The device according to claim 2, wherein the two-column pixel electrodes include a plurality of units, which are formed of the first and second pixel rows one by one or more, and
the first and second pixel rows are arranged inverted between neighboring two units.

4. The device according to claim 3, wherein the predetermined area is a boundary area between the neighboring two units.

5. The device according to claim 3, further comprising:
a drive circuit configured to apply a display signal voltage to the signal line, the display signal voltage being a voltage in which a voltage polarity is inverted with respect to a voltage polarity of a common electrode in every horizontal period corresponding to the number of pixel rows of the unit.

6. The device according to claim 5, wherein the drive circuit inverts the voltage polarity of the display signal voltage applied to the signal line for every frame.

7. The device according to claim 5, wherein the common electrode is provided so that liquid crystal is interposed between the first and second pixel electrodes.

8. A liquid crystal display device comprising:
first display pixels, which are arrayed as a first pixel column along a first signal line; and
second display pixels, which are arrayed as a second pixel column along the first signal line so that the first signal line is positioned between the first pixel column and the second display pixels,
one of the first display pixels and one of the second display pixels being arranged adjacent to each other in every pixel row,
a predetermined number of continuously arranged pixel rows forming a unit,
a display pixel of a mutually different column between neighboring two pixel rows being connected to the first signal line, in the unit,
a select pattern of a display pixel given as a connection target to the first signal line being a select pattern in which the display pixel is mirror-inverted using a direction orthogonal to the first signal line as an axis between two units neighboring along the first signal line.

9. The device according to claim 8, further comprising:
a second signal line, which is arranged via the first signal line so that the first pixel column is positioned,
the second signal line being connected with a display pixel, which is not connected to the first signal line, of the first display pixels.

10. The device according to claim 9, further comprising:
a third signal line, which is arranged via the first signal line so that the second pixel column is positioned,
the second signal line being connected with a display pixel, which is not connected to the first signal line, of the second display pixels.

11. The device according to claim 8, further comprising:
a drive circuit configured to apply a display signal voltage to the first signal line,
the display signal voltage being a voltage in which a voltage polarity is inverted with respect to a voltage polarity of a common electrode in every horizontal period corresponding to the number of pixel rows of the unit.

12. The device according to claim 11, wherein the drive circuit changes the voltage polarity of the display signal voltage at a timing when a unit corresponding to a display pixel writing the display signal voltage changes.

13. The device according to claim 11, wherein the drive circuit inverts the voltage polarity of the display signal voltage applied to the signal line for every frame.

14. The device according to claim 10, further comprising:
a drive circuit configured to apply a display signal voltage to the first signal line,
the display signal voltage being a voltage of inverted polarity with respect to a voltage polarity of a common electrode in every horizontal period corresponding to the predetermined number.
the drive circuit applying a display signal voltage having a voltage polarity, which is different from the display signal voltage applied to the first signal line, to the second and third signal lines.

15. The device according to claim 8, wherein the predetermined number is an integer more than two.

16. A liquid crystal display device comprising:
a first signal line, which is arranged in a predetermined direction;
a second signal line, which is arranged in parallel with the first signal line and adjacent to the second signal line; and
display pixels arrayed in one column along the first and second signal line between the first and second signal lines,
the display pixels being configured so that a predetermined number of continuously arrayed display pixels form a unit,
a display pixel being connected to one of the first and second signal lines so that a signal line connected with a display pixel is mutually different between two display pixels neighboring in the column direction, in the unit,
a select pattern of a signal line given as a connection target to a display pixel is mutually inverted between neighboring two units.

17. The device according to claim 16, further comprising:
a drive circuit configured to apply a display signal voltage to the first signal line,
the display signal voltage being a voltage of inverted polarity with respect to a voltage polarity of a common electrode in every horizontal period corresponding to the predetermined number.

18. The device according to claim 17, wherein the drive circuit applies a display signal voltage having a voltage polarity, which is different from the display signal voltage applied to the first signal line, to the second and third signal lines.

19. The device according to claim 18, wherein the drive circuit inverts a voltage polarity of a display signal voltage applied to the first signal line and a voltage polarity of a display signal voltage applied to the second signal line for every frame.

20. The device according to claim 16, wherein the predetermined number is an integer more than two.
